(19) United States
(12) Patent Application Publication
(10) Pub. No.: US 2013/0290072 A1
(43) Pub. Date: Oct. 31, 2013

(54) Automated Planning, Value Calculation And Decision Optimization System And Method

(71) Applicant: Tom Yitao Ren, Bellaire, TX (US)

(72) Inventor: Tom Yitao Ren, Bellaire, TX (US)

(21) Appl. No.: 13/870,972

(22) Filed: Apr. 25, 2013

Related U.S. Application Data
(60) Provisional application No. 61/637,858, filed on Apr. 25, 2012.

(51) Int. Cl. G06Q 10/06

(52) U.S. Cl. CPC G06Q 10/0637
USPC 705/7.36

(57) ABSTRACT

A computer-driven and implemented automated planning, value calculation, and decision-making system and method allows a user to calculate the actual value of current and future decisions based on user-defined values, by projecting future income, and monetization and other elements that may impact the user from possible decisions, provides a value range to uncertain factors, and then converts them into current value to optimize specific plans and decisions. The system also allows a user to quantify personal non-monetary and emotional factors and, at the same time, it provide ranges to uncertain values, and allows the user to specify monetized numerical amounts and ranges, and therefore the result is more personalized. It provides multi-level forecasting and synthesized analysis of possible future choices based on a user's preference, education, culture, decision-making history and other factors.

### CROSS REFERENCE TO RELATED APPLICATION

This application claims priority of U.S. Provisional Patent Application Ser. No. 61/637,858, filed on Apr. 25, 2012.

### BACKGROUND OF THE INVENTION

1. Field of the Invention

This invention relates generally to computer-driven and implemented planning, value calculation, and decision-making systems and, more particularly, to a computer-driven and implemented automated planning, value calculation, and decision-making system and method that allows a user to calculate the actual value of current and future decisions based on user-defined monetary, non-monetary, personal and emotional factors, and other elements that may impact the user, by projecting future income, personal goals, lifestyle achievements and other factors that may impact the user from possible decisions, provides a value range to uncertain factors, and then converts them into current value to optimize specific plans and decisions.

2. Background Art

In many cases, people do not know what would possibly happen after a certain decision is made, or what they would consider the most important thing in the future because the importance factors change over time, or which decisions they will make in the future—they only know what is more important at the moment.

There are a large number of patents that disclose various financial planning and decision-making programs based on monetary time value calculations, current and future cost of different choices, value creation, net present value, discounted cash flow, and future financial projections. However, there are few patents directed toward planning and decision-making systems and methods that include non-financial personal life-choice scenarios and events.

Stiegler, U.S. Pat. No. 5,774,121, discloses a computer system and method that operates on a number of user interfaces to provide a graphical decision making tool that allows a user to graphically define and manipulate objects representing options, criteria, and ratings, to analyze and produce a decision. The user interfaces include an option rating window for each criterion for categorically rating the options with respect to the criterion. The option rating window includes a number of columnar category areas representing various categories for graphically evaluating the options, and a number of special rating areas for ascribing particular non-linear evaluations. The category areas are mapped to numeric rating scales so that the graphical position of a rating (associated with both an option and a criterion) produces a numeric rating for the option. The user interfaces further include a criteria weighting window for graphically establishing a criteria weight for each criterion. The user interfaces further include a decision table window that displays a matrix defined by the options and criteria and that displays the qualitative evaluations and summary ratings for each option, where the summary ratings of an option are based on the numeric ratings for the option.

Ulwick, U.S. Pat. No. 5,963,910, discloses a computer program product for providing a process for strategy evaluation and optimization, comprising a computer-readable medium of instructions for directing a computer to evaluate data for optimizing strategic options including: (1) data storage means for storing data relating to specific desired outcomes relating to a specific process for an identified customer set; (2) the data storage means further storing data relating to metrics which predict the satisfaction of the desired outcomes; (3) data processing means including computer program means for quantifying the degree to which each of the metrics predict satisfaction of each of the customer desired outcomes; (4) input means for defining strategic options, each of the options designed to satisfy the customer desired outcomes; (5) data processing means including computer program means for quantifying the degree to which each of the strategic options satisfy the customer desired outcomes; (6) and means for evaluating a plurality of strategic options thus yielding a strategic option which best satisfies the customer desired outcomes.

Merrill et al, U.S. Pat. No. 5,954,510, discloses an interactive system and method for assisting people in achieving and learning to achieve self-determined, measurable goals over time that collects data from a user on the user's progress toward achieving the goals. Metrics are computed from the data which gauge the user's progress towards achieving the goals, and performance feedback is provided to the user. Additional information may be collected from the user regarding their estimate of the likelihood of achieving the goals, and a separate computation may be made of an objective estimate of the user's likelihood of achieving the goals. Random or scheduled, positive or negative psychological reinforcement may also be provided to the user. Preferably, a computer-based system is employed for implementing the method in which a computer system receives and stores all of the collected information, computes the metrics and generates the performance feedback in the form of a progress report. Any suitable input device, such as a touch-tone telephone for example, may be employed for entering the data into the computer system, while any suitable output device, such as a facsimile machine, may be employed for communicating the performance feedback to the user

Grosser et al, U.S. Pat. No. 7,130,836, discloses a computer-aided decision-making system and method that is applicable to a variety of decision-making contexts and applications such as, but not limited to, automobile or home purchase decisions. The computer-aided decision-making system provides immediate, useful, and relevant information to a person in a decision-making context, overcoming common human cognitive problems that occur in decision-making, and enabling consumer purchases in an on-line sales environment. Aspects of the invention that aid a person in decision-making include, but are not limited to: managing all the sub-decisions, educating the decision-maker, highlighting the most important sub-decisions, offering the most viable proposals for evaluation, distinguishing significant differences between proposals, supplying various evaluation tools, preventing blind spots, assisting the decision-maker's memory, gauging the progress of the decision process, and learning about the decision maker from the decision process.

Pellinat, U.S. Pat. No. 7,287,017, discloses a software-based decision engine that implements a comparative or opportunity based decision making methodology. A user selects or provides options and influencing factors. The importance of each influencing factor, and the reason for each factor's importance, is obtained. Each factor for each option is weighted, and any extra effort associated with a particular option is assessed. Resources and on-line links may be provided to assist in weighting factors. The factors may be pre-weighted based on quantifiable information. The options are ranked and displayed in a scorecard format, wherein the importance, reason and weight behind each factor of each option is displayed to the user, providing the user with quantifiable knowledge that he/she has made the best decision based on all available options and associated factors. Steps for developing an action plan to make a chosen option a reality may also be provided.

Zangwill, U.S. Pat. No. 7,676,446, discloses systems and methods to assist in making decisions that consider situations where the user is determining which of several alternatives is the best choice. The criteria to evaluate the decisions are input into a grid, and the user rates the different alternatives against the different criteria. Given several alternative choices or options, it provides the probability each alternative is the right selection. In one embodiment, the system implements a Bayesian approach. The systems and methods may estimate the chance some important consideration was missed thereby reducing the chance of being surprised or blindsided. The system and method may also examine the inputs to a decision analysis in order to detect entries that might reflect bias, assumptions or unusual reasoning, thereby increasing the chance of obtaining the correct answer. The systems and methods may also identify the factors that were predictive. The systems and methods do not accept information as valid and correct; rather, they allow cross-checking and verification, and further employ sub-systems and sub-methods to reduce mistakes. Systems and methods so disclosed may be employed in financial analyses, intelligence analysis, etc.

Redweik, U.S. Pat. No. 7,844,526, discloses a data-driven computer-facilitated financial model Life-Time Value (LTV) system that provides accurate and consistent profitability projections using current period account level profitability data stored in a Relational Database Management System (RDBMS). The Life-Time Value system performs Net Present Value (NPV) and Future Value (FV) processing using business-rule and data-driven applications that embrace the current period profit components, defines forecast periods, parameters and methodologies, and applies appropriate growth values, attrition values and propensity values to an object of future value interest.

Pinckney et al, U.S. Pat. No. 7,958,066, discloses an interactive machine learning advice facility for helping a user make a decision through the use of a machine learning facility. The process may begin with an initial question being received by the machine learning facility from the user. The user may then be provided with a dialog consisting of questions from the machine learning facility and answers provided by the user. The machine learning facility may then provide a decision to the user based on the dialog and pertaining to the initial question, such as a recommendation, a diagnosis, a conclusion, advice, and the like. In embodiments, future questions and decisions provided by the machine learning facility may be improved through feedback provided by the user.

Kellogg et al, U.S. Pat. No. 8,065,261, discloses methods and a system for comparing a plurality of different options in a decision making process which includes entering a plurality of factors; determining a plurality of decision options based on the plurality of factors; calculating a score for the plurality of factors; ranking each decision option based on the total score of each factor; and outputting the rankings for each decision option.

Brenner, U.S. Patent Publication 2011/0055065, discloses a method of decision making using artificial intelligence that: receives data associated with a user regarding the situation of the user; identifies action options that the user might pursue; computes normalized scores for each of the action options based on the eligibility and likely outcome of the user pursuing the respective action option; compares the scores to a minimum threshold and to each other using quantitative and qualitative metrics; outputs a list of action options to the user as primary and secondary options to pursue based on the comparison; receives a selection from the user based on the list of action options; and transmits a message to a party who provides the action option(s) based on the selection. The method is, for example, applicable to decision making in the context of personal finance and debt assistance.

Ratnam et al, U.S. Patent Publication 2012/0030160, discloses a method for providing automated decision in response to one or more responses. The method includes providing, at a computer system, a user interface for receiving input from a user. The method also includes detecting a first event. The method further includes receiving a first set of attributes associated with the first event. Also, the method includes processing the first set of attributes. The method additionally includes analyzing the first set of attributes using at least pattern recognition. The method includes determining a first context for the first event based at least on the first set of attributes.

My previous patent, Ren, U.S. Pat. No. 7,587,377, discloses a computer driven information management system selectively ranks and qualifies third-parties, such as vendors, by utilizing user-defined and selected questions and qualification criteria from various data sources to utilize the database information available in public, commercial or in private, or by information directly supplied by the third-party in a registration with the organization desiring information from the third-party. The system displays the results of the scoring system for user selection. Alternatively, the system can automatically generate a notification of selection to the organization, the user and the third-party from whom the information was obtained.

### SUMMARY OF THE INVENTION

The present invention overcomes the aforementioned problems and is distinguished over the prior art in general, and these patent in particular, by a computer-driven and implemented automated planning, value calculation, and decision-making system and method that allows a user using a general purpose computer workstation having a central microprocessor unit with at least one local or remote memory component, a graphical user interface, a user input device, a display, and computer readable programs stored thereon, to calculate the actual value of current and future decisions based on user-defined and quantified monetary, non-monetary, personal and emotional factors, and other elements that may impact the user from possible decisions. The present system and method provides a value range to uncertain factors, and converts them into current value to produce a personalized synthesized analysis and multi-level forecast of possible monetary and non-monetary choices. The present system and method allows a user to project future income, and life based on monetization and other elements that impact the user from possible decisions ranked by importance, to give a range of values to uncertain factors, and then convert them into current value to optimize specific plans and decisions.

The system requires the user to estimate and enter monetized income and quantified non-monetized elements based on importance into the system, and forecast results to a period of time in the future. The user can conveniently select the best decision option from the numerically displayed results.

The planning phase of the system is based, in part, on money time value calculation, opportunistic cost with time variance, current and future cost of different choices and possibility ranges, value creation, discounted cash flow based on future projections (“discounted cash flow model”), as well as scenario analysis and optimization, discount quantified future possible elements and choice options, scenario analysis and optimization, including algorithms for multi-stage optimization by focusing on key parameters resulting in faster and more accurate calculations. The present system and method allows a user to self-define rules and standards and to achieve goals using scenario analysis in different aspects of life and production fields.

The present system and method utilizes scenario analysis and optimization, which includes algorithms for multi-stage optimization by focusing on key parameters and linear and non-linear programming solvers. It records a user's preference, education, culture, decision-making history, and forecast possible future variables. When a user is unable to decide what would possibly be important in the future for current decision making, the system can make the decision based on the synthesized information in the database for the user and quantify the options. The system provides options for future forecasting under these unknown conditions, for example, system may forecast that by attending a good college the user can possibly meet a good life partner and also attain potential work relationships. The user may like to spend more time and money now for education and/or work, however after 10 years the same user may want to do more charity work or enjoy family relationships; if the user grow up in an entrepreneurial spirit family, it's very likely the user will start a business after a certain number of years.

Through forecasting the possible future choices, the system can rank the most likely choice the user will make, and convert into current value to provide feedback to the user on current decisions. In some cases, user has certain preferences over time, for example, the user may have three options for different universities and study majors, and after graduation, the user can choose to continue his or her education, work, or start a business. Each option then has other future choices (e.g. continuing education has the option of working and starting a business, working has the option to go back to school to continue their education, or start a business, etc.). If a user prefers change over time, then he or she can set a preferred value for “working”, “start a business” and “continue education” and the system will automatically run a scenario analysis. The system achieves the scenarios analysis and multi-stage optimization by using linear and non-linear programming solvers to calculate the optimal solutions based on the variables and constraints.

The system can also take user's gender, and time frame into consideration, together with certain emotional factors that cannot be given a certain number, thus, the evaluation will be more customized to each individual user. For example, a male and female at the age of 20-25, may have the same level of focus on career, and the difference will be more focused on individual preferences than overall gender difference; however, after 30 years, the system can give male users 70-100 for career focus while giving female 50-90 for the same element because overall male gender have more focus on career than female, and it's hard to define a certain number for a person 10 years from now.

The technology of the present system can also be used for choosing the best buyers or clients for businesses based on: current and future sales, the cost of sales to each specific buyer, and consideration of other factors such as brand recognition, reputation, competition, business sales preference, etc., which is quantified and then converted into present value, to choose the best and ideal buyer. The present system may also be used to quantify factors that typically do not show as a monetary figure, such as for example, to look for the most suitable colleges for students, most suitable employer, or life partner etc. In the event of priority or preference changes, the user can modify and change settings in the system, in order to find the most suitable target for each period of time.

One of the significant features and advantages of the present invention is that it provides simple, efficient, automated calculation of forecasted future income, cost, risk, and lifestyle changes, using discount cash flow, linear or non-linear calculations, to quantify and analyze future possibilities.

Another significant feature and advantage of the present invention is that it allows a user to define multiple level preferences, quantify future projected income, and receive an evaluation that better meets the user's specific requirements.

Another significant feature and advantage of the present invention is that it allows a user to quantify personal and emotional factors and non-monetized values, and at the same time, the system provides ranges for uncertain values, allows the user to specify numerical amounts and ranges based on the importance to the user, and therefore the result is more personalized.

Another significant feature and advantage of the present invention is that it provides multi-level forecasting and synthesized analysis of possible future choices based on a user's preference, education, culture, decision-making history and other elements, and if the user can't provide such information, the system will provide multi-level forecasting and synthesized analysis of possible future choices based on current knowledge.

Another significant feature and advantage of the present invention is that it provides scenario analysis, therefore the results are more flexible and automated to meet specific requirement.

Another significant feature and advantage of the present invention is that it can track a user's selections; ensure each goal is achieved on time, and that each selection is beneficial to meet the user's goals.

A further significant feature and advantage of the present invention is that it uses predefined measurements of users selections, to give feedback on each decision that a user may take, automatically re-calculated when an selection is taken, and warns the user when user is about to make an irreversible decision.

A still further significant feature and advantage of the present invention is that the decision making process takes a time frame into consideration, not only in forecasting future uncertain elements, but also in providing the best short-term and long-term result to the user.

Other features and advantages of the invention will become apparent from time to time throughout the specification and claims as hereinafter related.

### BRIEF DESCRIPTION OF THE DRAWINGS

FIG. 1 is a simplified block diagram of the major components of the computer-implemented system for carrying out the automated planning, value calculation, and decision-making process of the present system.

FIG. 2 is a simplified flow diagram illustrating a general overview of the steps in the process and method of the present invention.

FIG. 3 is a simplified flow diagram illustrating the process of entry of exemplary personal profile and emotional factors that may have an influence on a user's decision.

FIG. 4 is a simplified flow diagram illustrating the process of quantifying and assigning a value to the exemplary personal profile and emotional influence factors.

FIG. 5 is a simplified flow chart illustrating the process of entry and comparison of monetized factors that may have an influence on a user's decision.

FIG. 6 is a simplified flow chart illustrating an example of calculated monetary return options based on the user input and computer generated factors.

FIG. 7 is a graph illustrating an example of calculated net present value (NPV) and discounted cash flow scenarios over time based on the user input and computer generated factors.

FIG. 8 is a simplified flow chart illustrating an example of the process of tracking the decisions made by a user.

### DESCRIPTION OF THE PREFERRED EMBODIMENT

The computer-driven and implemented automated planning, value calculation, and decision-making system and method allows a user to calculate the actual value of current and future decisions based on user-defined values, by projecting future income, and monetization and other elements that impact the user from possible decisions, gives a range to uncertain factors, and then converts them into current value to optimize specific plans and decisions.

It should be understood that some of the operations of the present computer-driven and implemented automated system are carried out by a user using a general purpose computer having a central microprocessor unit with at least one memory component, a graphical user interface and a user input device such as a keyboard, pointing device or touch screen coupled with the microprocessor operable by a user for inputting data. These components are conventional in the art, and therefore not shown and described in detail.

FIG. 1 is a simplified block diagram of the major components of the computer-implemented system for carrying out the automated planning, value calculation, and decision-making process of the present system. The system includes an “elements define” program 901, a “quantifying program” 902, a “projected options define” program 903, a “calculation program” 904, a “decision-making program” 905, a “user information” database 906, a “calculation model” database 907, a “define calculation model” program 908, a “tracking” program 909, and a monitor or display device 910 coupled with the microprocessor for displaying graphics and data.

The “elements define” program 901 is used to define decision making elements and factors that will influence the decision making process. The “quantifying” program 902 allows a user to quantify each of the decision-making elements, and provide a range of values to the ones that are deemed uncertain as to a specific numerical value. The “define projected options” program 903 defines future options, and based on projected options, selects a decision making element collection from all or part of the decision-making elements. The “calculation model” database 907 is used to establish and store all calculation models, such as discount cash flow models, linear and non-linear programming, including opportunity cost, current cost, and future projected cost, etc. The “define calculation model” program 908 used to select a calculation model from the “calculation model” database 907. The “calculation” program 904 is used to calculate the data according to the selected calculation model retrieved from the calculation model database 907 and according to the selected time and present value options. The “decision-making” program 905 is used to compare specific time frame value calculations, and select the best option at a given time. The “tracking” program 909 collects inputted user selections after a decision is made, and estimates if a certain selection by the user will benefit or harm the decision. The display device 910 displays the listed options and decisions data in graphics and text and may display the options and decisions in different colors.

More specifically, the “tracking” program 909 updates the decision making elements, automatically updates, and provides new results after a certain selection is made by the user, then executes a comparison calculation to determine whether the new result is better or worse than the previous result, pushes a notification to the user, and at the same time, saves the user selection in the user preference information database, quantifies the preference and then saves it in the preference information database.

The automate planning and optimization process includes the following steps:
Step A: Define elements that influence decision-making, and quantify each element;
Step B: Project an anticipated option, select all or part of the elements in the elements collection, wherein the numerical value of all the elements at a certain time will be the weighted value;
Step C: Select a calculation model from the model database, and automatically input elements, values, and costs at specific time;
Step D: Compare projected options at a specific time, and select the best option;
Step E: Collect user selections, estimate if certain selections are beneficial for the user to reach the goal; and
Step F: Display a notification of results to the user and display user selections, using text and/or different color variations to highlight or showcase different levels of benefits and costs.

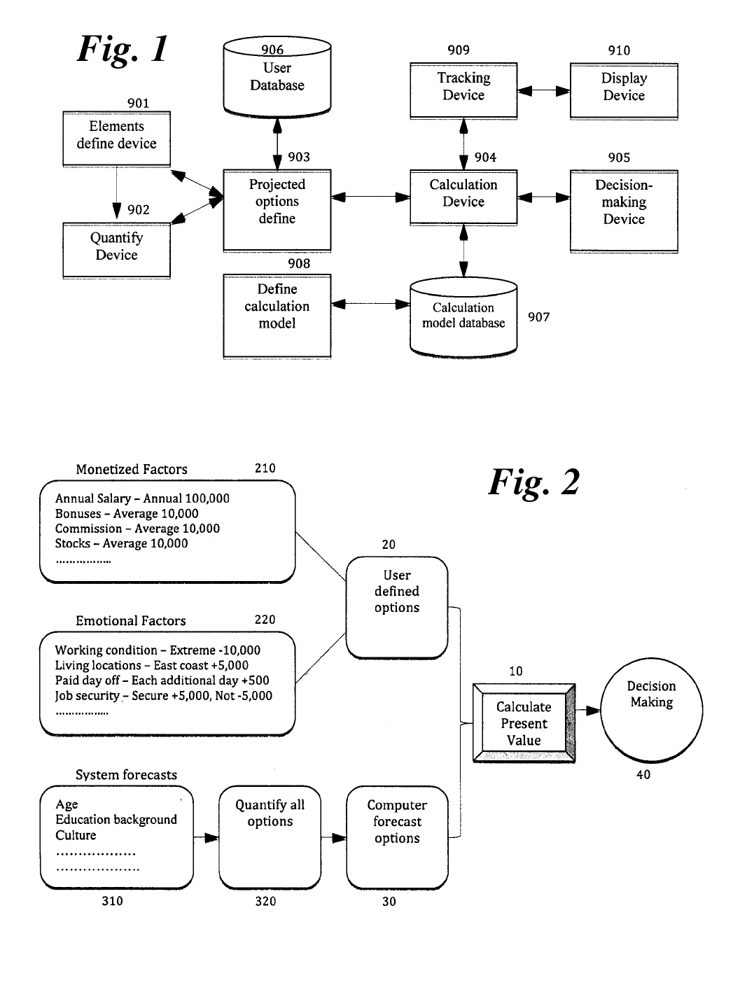

As indicated in FIG. 2, the system allows a user to consider monetized factors 210 and personal non-monetary emotional factors 220, thus define future possible options 20; or the user may allow the system to generate forecasted possible outcomes or options 310, based on the user's inputted personal information, when the user is unsure about certain criteria. The system then allows the user to quantify both emotional and monetized numerical factors 320, and calculates computer generated forecasted options 30 and the user defined future possible options 20. The system calculates the net cash flow of each possible future option, and calculates the Net Present Value (NPV) of the future cash flow 10 of each possible decision, compares the Net Present Values (NPV), and presents the best option for the user to make the decision 40.

Most people make decisions based on how they feel instead of accurate reasoning. The present system considers both monetized factors 210 and a range of quantified emotional factors 220 that may have an impact on the user, within predefined limits, while giving a real numerical value to each decision, thus the emotional factors will be complimentary to the underlying real reason for the decision, but will not to take over or be a substitute for the real reason.

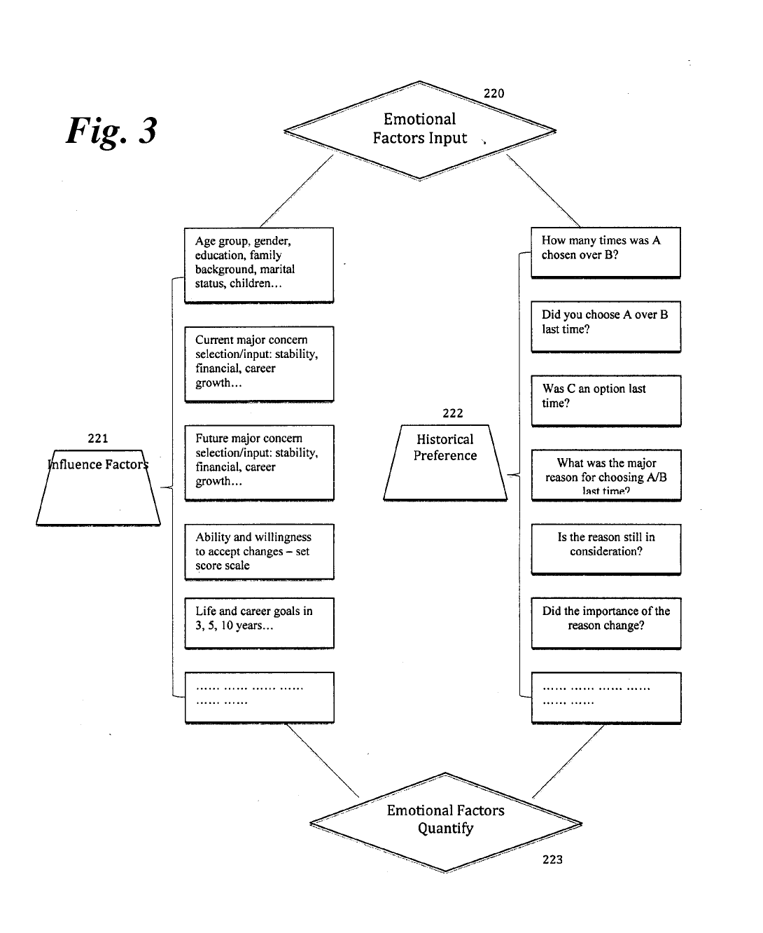

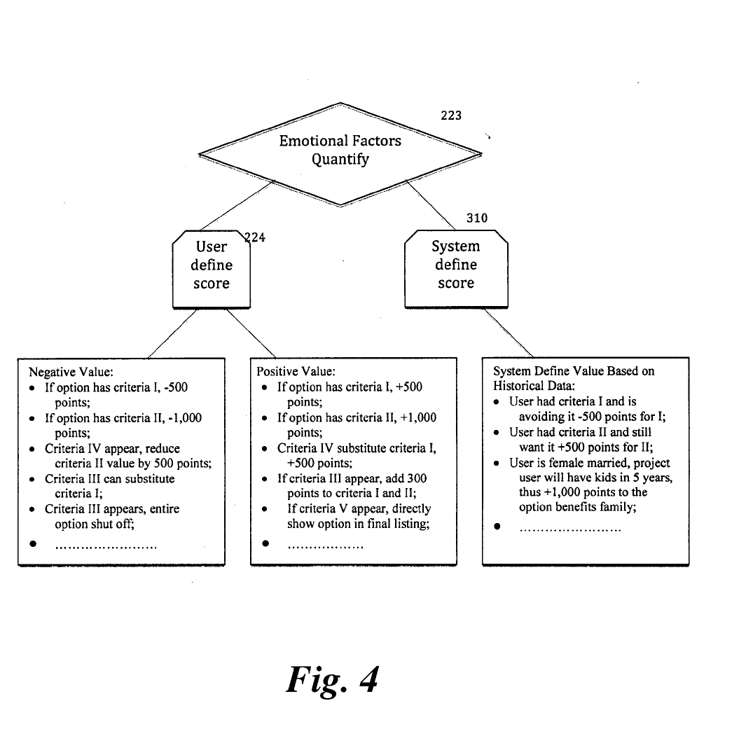

As illustrated in FIG. 3 and FIG. 4, the program asks the user to input personal profile and preference factors such as: age, gender, education, family, background, marital status, current major concerns, future major concerns, ability and willingness to accept changes, life and career goals in the coming years. All the personal profile and preference factors input by the user constitute Influence Factors 221 and will be used by the program to calculate, estimate, and forecast, the user's best future preferences.

The program asks the user to input historical preferences 222 such as: if the user has chosen certain criteria before; if the user wants to choose the same criteria now and in the future or attempt to avoid it; if a certain criteria was an option in the history of making decisions, what are the major reason for making certain decisions; are certain criteria still in consideration; if the importance has changed, etc. After all the historical criteria are set, the user can then quantify 223 the emotional factors and non-numerical factors by setting a dollar amount for each factor, either in a positive or negative value.

For example, if the user doesn't like uncertainty, and would rather to sacrifice $5,000 annual potential earnings for a more stable job, then the user can either enter $5,000 for a relatively stable job, or enter −$5,000 for a risky job. At this level, the user not only can set a positive or negative value, but also may choose to substitute certain criteria with others, or may replace then add more value or decrease a value in the new criteria. As an example of a query for “life and career goals”; if relocation to Australia is a potential option, the program may automatically disregard a negative 5,000 points for not being stable, and give it a positive 1,000 points if the Australia relocation is in Melbourne city, or the user may set an extreme condition and allow the system to automatically send certain options directly to user as one of a final decision considerations. For example, if attending a university was a selected user goal, and the university provides jobs upon graduation, the program automatically sends this option to the user for final decision consideration. The program may also directly eliminate certain options for further consideration when the option is reaching “bottom line”. For example, in response to a query for “life and career goals”; if going abroad is not an option, the program may directly eliminate this option for future consideration. After all quantification processes are completed, the program will automatically convert current and future value and cash flow to present value, compare the results and provide user with the best option upon analysis.

The system can also take the user's gender, and time frame into consideration, together with certain emotional factors that cannot be given a certain number, thus, the evaluation will be more customized to each individual user. For example, a male and female at the age of 20-25, may have the same level of focus on career, and the difference will be more focused on individual preferences than overall gender difference; however, after 30 years, the system may give male users a point value of 70-100 for career focus, while giving a female a point value of 50-90 for the same factor because overall, the male gender has more focus on career than female.

Thus, the present system allows quantifying and discounting of many factors, for example, allows a user to monetize impact on reputation, time and/or energy, potential action required for goal choices, value of vacation time for employees, future job seeking opportunities for college students, mutual compatibility for life partners, etc. and discount future possibilities to present value. The present system can also be used for “relationship compatibility worth” calculation and evaluation, especially for long-term exclusive relationship evaluation, such as choosing the best buyers for businesses, or choosing the best life partner based on preference and benefits, such as education background, future growth, income, mutual compatibility calculation, etc.

In these situations, “reinforcement” such as positive feedback and negative feedback will in turn impact on the user who is making the decision, and therefore consideration of these factors in the calculation and decision-making provides significantly more accurate and reliable results. For example, all things being equal, a future life partner that came from a similar background may better understand issues such as children's education, thus lead to a happier life, and healthier family, which may in turn impact on user's career development. In the event of priority or preference changes, a user can simply modify and change settings in the system, in order to find the most suitable target for each period of time. The present system may be used to simplify, and calculate, the best choice when there is more than one option.

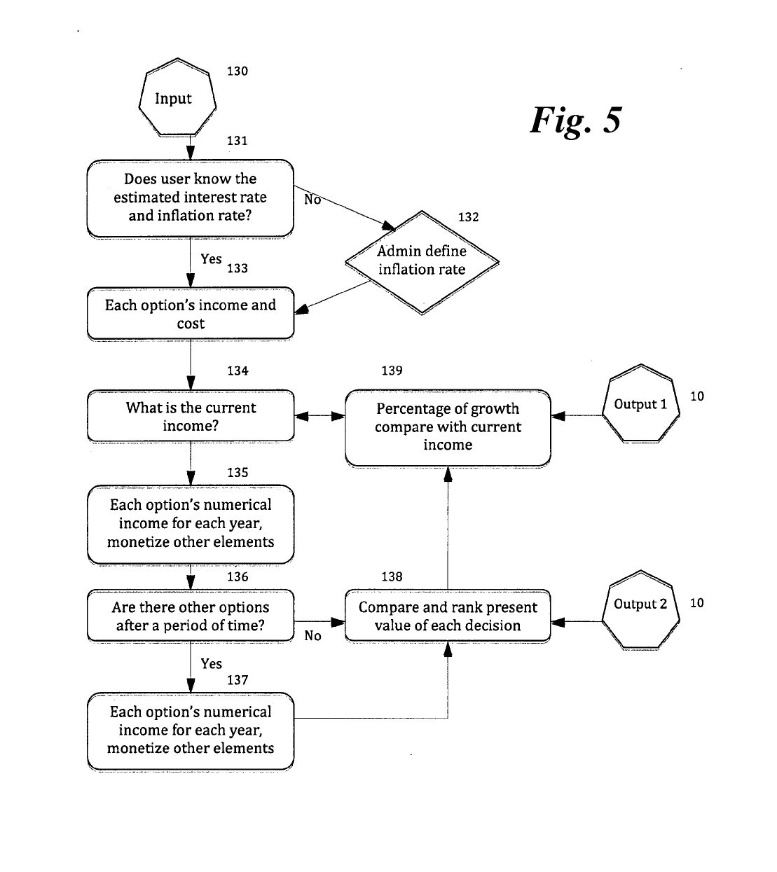

FIG. 5 is a simplified flow chart illustrating a real monetized calculation after quantifying all the non-monetized factors. The planning phase of the system is based, in part, on money time/value calculation, opportunistic cost with time variance, current and future cost of different choices and possibility ranges, value creation, discounted cash flow based on future projections (“discounted cash flow model”), as well as scenario analysis and optimization, discount quantified future possible elements and choice options, scenario analysis and optimization, including algorithms for multi-stage optimization by focusing on key parameters resulting in faster and more accurate calculations. The present system and method allows a user to self-define rules and standards and to achieve goals using scenario analysis in different aspects of life and production fields.

The calculation input 130 starts with the user entering a user defined discount rate 131, if user doesn't know the discount rate, system will use a default discount rate 132, then the user is prompted to input monetized future decision options 133, and the current income 134. If there are emotional factors that impact the user's decision, the user would be given an opportunity to quantify each factor 135. After certain period of time, if there are other options and values 136 and 137 needed by the user to make decisions, the user will use the same process as 133 and 135 to enter the additional data at this point. The program then compares, calculates, and ranks 138, 139, the Net Present Value (NPV), and displays the output 10 to the user, for user to make the decision.

In this process, the user enters current and future estimates of different monetized income and quantified non-monetized factors 135, and forecasts to a period of time in the future. At the same time, the user may estimate and enter the different costs according to each estimated income. Thus, the user can conveniently select the best decision option from the numerically displayed results. The system allows user to project cost and income with various combinations of possibilities and time frames. For example, the user can forecast future choices based on personal knowledge, or based on system recommendations, or both. The user can also forecast the next 5 years, 10 years or 20 years into the future. After user enters projected values, the system then automatically calculates net annual value (income-cost) and net present value (NPV) using the user-entered numbers, and the numbers calculated by the program formula as follows:

Discounted Cash Flow (DCF)=CF₁/+CF₂/(1+r)²+ . . . +CFₙ/(1+r)ⁿ

where cash flow is net cash flow, which is the inflows and outflows difference, r=discount rate (WACC) where user may define the discount rate, or using the system default rate, n=time period of the cash flow, frequency can be monthly, quarterly, semiannually or annually. The equation may also be expressed as:

$$N P V = {\sum }_{t = 0}^{n} \frac{{( Benefits - Costs )}_{t}}{{( 1 + r )}^{t}}$$

Where r=discount rate, t=time and n=analytic horizon (periods), benefit includes all user quantified income, (including quantified emotional factors) Cost includes all user quantified costs, (including quantified emotional factors).

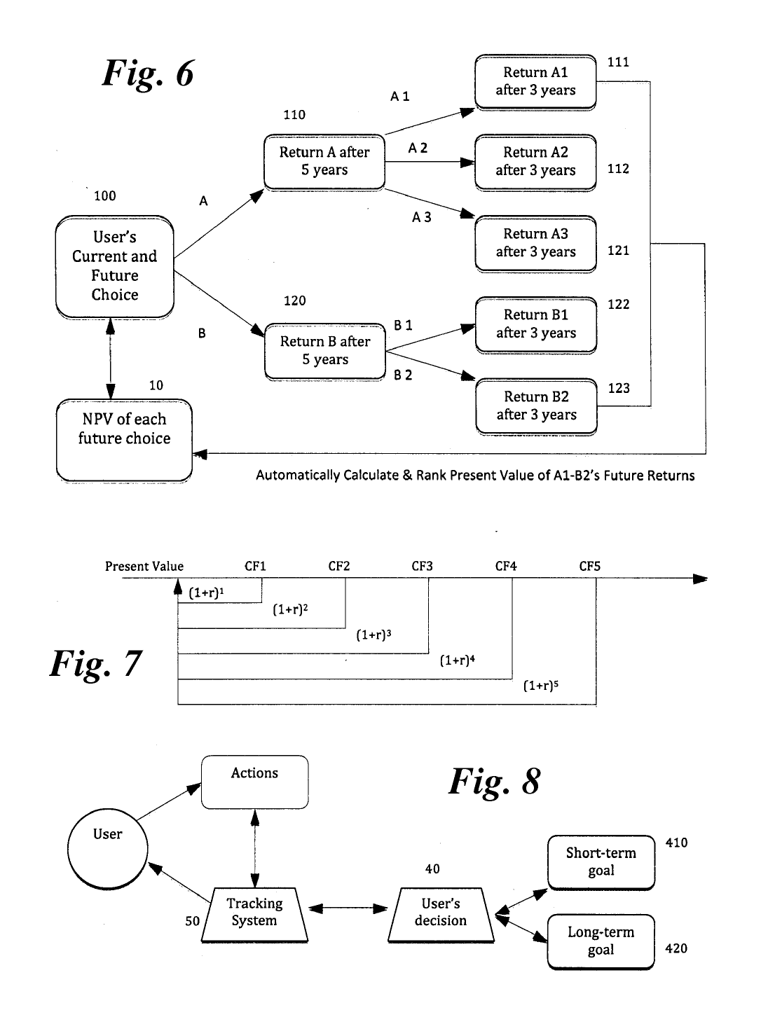

FIG. 6 and FIG. 7 illustrate how Net Present Valve (NPV) is calculated. As an example, the user currently has two options 100, and option A shows a return 110 after 5 years, and has three options A1, A2 and A3, showing returns 111, 112 and 121, respectively, in 5 years: and option B shows a return 120 after 5 years and has two options B1 and B2 which will show returns 122 and 123, respectively, in 3 years. The program will use above-described formula to calculate each option's net cash flow, and then calculate the NPV of each cash flow, followed by a linear and non-linear programming solver function to calculate the optimal solutions based on variables and constraints as shown in FIG. 6, and present to the user the NPV of all possible choices for the user to make the final decision.

This feature can also be used for business value calculations in order to assist business owners or executives in making decisions on business operations, such as which buyer or customer to focus on, or which part of the market to penetrate. The user can monetize the benefit or loss from non-monetized factors such as brand recognition, reputation, competition, business sales preference, etc. Based on user preferences and the ability to forecast each buyer, the system can run “what-if” scenarios by editing business cash flow projections, re-assessing each buyer's value change over time, calculate its possible future net cash flow and then convert each buyer's future value into present value. As shown in FIG. 7, the business' value is calculated by discounted cash flow of CF1-CF6. When the user manipulates and changes each sector of the most important numerical factors, such as sales, cost, value of buyer's brand, buyer's reputation, and then use the new monetized input combination to calculate the discounted cash flow, and find the most suitable clients. When the user is unable to set possible changes as one certain number, the program will allow setting up a range of values for the changes. The program also allows the user to set possibilities for each possible change, and calculate the present value based on the possibility of changes to happen, together with discount cash flow and linear and non-linear calculation.

The present system may also be used for suppliers to evaluate buyers, or investors to evaluate businesses they plan to purchase or invest in. Using investors as an example; investors can estimate and forecast income for the following 5 or 10 years, monetize clients' value, reference, reputation, etc., and discount these factors to the current year. By using this technology, an investor can obtain the most accurate valuation for the net business worth. In cases where investors have many choices and limited funding, calculating business net worth will allow accurate forecasting and calculation of best investment decisions out of all given choices. Furthermore, the system allows investors to estimate bid-ask spread, seller and buyers' expectations of business potential, and then determine how much time to spend on the project, and the likelihood of successful acquisition of a business, etc. In a situation where a business is for sale, merger, or acquisition, the system will be able to automatically ask questions to business owners, (such as the business net value) and quantify those that are not quantified, and use the quantified factors to calculate and estimate the business value.

A user can also set the system to provide feedback. For example, the system can ask a business owner about risk factors, how much risk may be involved, how great or small the chances that the business may fail, etc. Based on projected sales and criteria, the system will automatically ask if owner is willing to “bet” on the business potential and reach sales projection (use personal assets or business value to guarantee their answer, and take the business risk). If business owners are willing to use personal assets to guarantee business debts or investments, the system will rank the business as more “trustworthy” when quantified, and then provide suggestions to user. Based on the system suggestion, the user and business owner may agree on the business net worth levels, e.g. 120% of current calculated value if the owner is willing to take the risk, and the promised goal actually achieved, or if not, 80% of current calculated value, or something similar. This factor could also be used for client valuation for special orders with a low price, or to calculate client value; if the client could give guaranteed purchase volume in the future, thus, providing additional value.

As illustrated in FIG. 8, once the user makes a potential decision selection and starts to use the tracking program 50; every time the user makes a selection, the program automatically tracks and analyzes the selection and determines if the selection will have a positive or negative effect on meeting the goal of the decision 40 and each of its short-term goals 410 and long-term goals 420. The tracking program will not only record, but also prompt and suggest necessary changes and modifications on short term and long term planning to make sure the user meets each milestone and is on track towards the final goal. The program tracks each decision selection and determines which decision selections may result in permanent or irreversible actions, and sends the user a red flag warning messages for at-risk actions, a yellow flag warning message for actions that may have negative effects on the projected goal, or a green pass for on-track actions.

While the present invention has been disclosed in various preferred forms, the specific embodiments thereof as disclosed and illustrated herein are considered as illustrative only of the principles of the invention and are not to be considered in a limiting sense in interpreting the claims. The claims are intended to include all novel and non-obvious combinations and sub-combinations of the various elements, features, functions, and/or properties disclosed herein. Variations in size, materials, shape, form, function and manner of operation, assembly and use, are deemed readily apparent and obvious to one skilled in the art from this disclosure, and all equivalent relationships to those illustrated in the drawings and described in the specification are intended to be encompassed in the following claims defining the present invention.

1. A computer-implemented automated planning, value calculation, and decision-making system for allowing a user to calculate the actual value of current and future decisions based on user-defined and quantified monetary, non-monetary, personal and emotional factors, and other elements that may impact the user from possible decisions, provide a value range to uncertain factors, and convert them into current value to produce a personalized synthesized analysis and multi-level forecast of possible choices, comprising:
a general purpose computer workstation having a central microprocessor unit, at least one local or remote memory component coupled with said microprocessor, a graphical user interface coupled with said microprocessor, a user input device coupled with said microprocessor, and a display coupled with said microprocessor;
a computer readable elements define data entry and processing program implemented in said computer workstation configured to allow a user to define decision making-elements and factors that will influence the decision making process;
a computer readable quantifying data entry and processing program implemented in said computer workstation configured to allow a user to quantify each of the decision-making elements and factors, and to provide a range of values to decision-making elements and factors that are deemed uncertain as to a specific numerical value;
a computer readable projected options define data entry and processing program implemented in said computer workstation configured to allow a user to define future options, and based on projected options, to select a decision-making element or factor collection from all or part of the decision-making elements and factors;
a computer readable calculation model database implemented in said at least one local or remote memory for establishing and storing calculation models, linear and non-linear programming, and associated benefits and costs;
a computer readable define calculation model data entry and processing program implemented in said computer workstation configured to allow the user to select a calculation model from said calculation model database to be used to carryout out calculations to forecast potential results and associated benefits and costs of decision making-elements and factors selected by the user;
a computer readable calculation data entry and processing program implemented in said computer workstation configured to allow a user to calculate data according to the selected calculation model retrieved from the calculation model database and according to selected time and present value options;
a computer readable decision-making data entry and processing program implemented in said computer workstation configured to allow a user to compare specific time frame value calculations, and select the best option at a given time;
a computer readable user preference information database implemented in said at least one local or remote memory for establishing and storing selections and preferences inputted by a user;
a computer readable tracking data entry and processing program implemented in said computer workstation configured to collect inputted user selections after a decision is made, and estimate whether a certain selection by the user will benefit or harm a potential decision, automatically update decision-making elements and provide new results after a certain selection is made by the user, execute a comparison calculation to determine whether the new result is better or worse than the previous result, display a notification of the result to the user, and save the user selection in said user preference information database, quantify the selection, and then save it in said user preference information database.

2. The system according to claim 1, wherein
said elements define data entry and processing program is configured to allow the user to define monetary factors and personal non-monetary and emotional factors that may be considered in influencing the decision making process, and to optionally allow the system to generate forecasted possible outcomes or options, based on the user's inputted personal information, when the user is unsure about certain criteria; and thereafter
said tracking data entry and processing program calculates and forecasts potential results and associated benefits and costs based on the monetary factors and personal non-monetary and emotional factors inputted by the user, or based the user's inputted personal information.

3. The system according to claim 1, wherein
said calculation model database includes a Net Present Value (NPV) calculation model; and
said calculation data entry and processing program is configured to calculate the net cash flow of each possible future option, and calculate the Net Present Value (NPV) of the future cash flow of each possible decision, compares the Net Present Values (NPV), and displays the best option for the user to make the decision.

4. The system according to claim 3, wherein
said calculation data entry and processing program is configured to calculate net annual value (income-cost) and net present value (NPV) using the numerical values inputted by the user or according to a calculation model, according to the equation:
Discounted Cash Flow (DCF)=CF₁/+CF₂/(1+r)²+ . . . +CFₙ/(1+r)ⁿ
where cash flow is net cash flow, which is the inflows and outflows difference, r=discount rate, where the user defines the discount rate, or using the calculation model default rate, n=time period of the cash flow, and frequency may be monthly, quarterly, semiannually o annually.

5. The system according to claim 3, wherein
said calculation data entry and processing program is configured to calculate net annual value (income-cost) and net present value (NPV) using the numerical values inputted by the user or according to a calculation model, according to the equation:
$$N P V = {\sum }_{t = 0}^{n} \frac{{( Benefits - Costs )}_{t}}{{( 1 + r )}^{t}}$$
where r=discount rate, t=time and n=analytic horizon periods, benefit includes all user quantified income, including quantified personal non-monetary and emotional factors, and cost includes all user quantified costs, including quantified personal non-monetary and emotional factors.

6. A computer-implemented automated planning, value calculation, and decision-making method that allows a user using a general purpose computer workstation having a central microprocessor unit with at least one local or remote memory component, a graphical user interface, a user input device, a display, and computer readable programs stored thereon, to calculate the actual value of current and future decisions based on user-defined and quantified monetary, non-monetary, personal and emotional factors, and other elements that may impact the user from possible decisions, provides a value range to uncertain factors, and converts them into current value to produce a personalized synthesized analysis and multi-level forecast of possible choices, comprising the steps of:
invoking a computer readable elements define data entry and processing program implemented in the computer workstation whereby the user defines decision making-elements and factors that will influence the decision making process;
invoking a computer readable quantifying data entry and processing program implemented in the computer workstation whereby the user quantifies each of the decision-making elements and factors, and provides a range of values to decision-making elements and factors that are deemed uncertain as to a specific numerical value;
invoking a computer readable projected options define data entry and processing program implemented in the computer workstation whereby the user defines future options, and based on projected options, selects a decision-making element or factor collection from all or part of the decision-making elements and factors;
storing calculation models, and associated costs in a calculation model database implemented in the local or remote memory;
invoking a computer readable define calculation model data entry and processing program implemented in the computer workstation whereby the user selects a calculation model from the calculation model database to be used to carryout out calculations to forecast potential results and associated benefits and costs of decision making-elements and factors selected by the user;
invoking a computer readable calculation data entry and processing program implemented in the computer workstation whereby the user inputs specific time options and present value options relative to a selected decision-making element or factor to be calculated according to the selected calculation model;
invoking a computer readable decision-making data entry and processing program implemented in the computer workstation whereby the user compares specific time frame value calculations, and selects the best option at a given time;
storing the selections and preferences inputted by the user in a computer readable user preference information database implemented in the local or remote memory; and
invoking a computer readable tracking data entry and processing program implemented in the computer workstation to collect inputted user selections after a decision is made, and estimate whether a certain selection by the user will benefit or harm a potential decision, automatically update decision-making elements and provide new results after a certain selection is made by the user, and execute a comparison calculation to determine whether the new result is better or worse than the previous result, display a notification of the result to the user, and save the user selection in the user preference information database, quantify the selection, and then save it in the user preference information database.

7. The method according to claim 6, wherein
said step of invoking said elements define data entry and processing program comprises the user defining monetary factors and personal non-monetary and emotional factors that may be considered in influencing the decision making process, and optionally allowing the system to generate forecasted possible outcomes or options, based on the user's inputted personal information, when the user is unsure about certain criteria; and thereafter
invoking said racking data entry and processing program to carryout out calculations and forecast potential results and associated benefits and costs based on the monetary factors and personal non-monetary and emotional factors inputted by the user, or based the user's inputted personal information.

8. The method according to claim 6, wherein
said step of invoking said elements define data entry and processing program comprises the user inputting personal profile and preference factors to be considered in the decision making process and used to calculate, estimate, and forecast, the user's best potential decisions.

9. The method according to claim 8, wherein
said personal profile and preference factors are selected from the group consisting of age, gender, education, family, background, marital status, current major concerns, future major concerns, ability and willingness to accept changes, life and career goals in the coming years, user's reputation, time and/or energy, value of vacation time, future job seeking opportunities, and mutual compatibility for life partners.

10. The method according to claim 8, wherein
said step of invoking said quantifying data entry and processing program comprises the user quantifying each of the inputted personal profile and preference factors by a positive or negative numerical value and/or a range of values to factors that are deemed uncertain as to a specific numerical value.

11. The method according to claim 8, wherein
said steps of invoking said elements define data entry and processing program and optionally allowing the system to generate forecasted possible outcomes or options comprises invoking said tracking data entry and processing program to carryout out calculations and forecast potential results and associated benefits and costs based on historical data and preferences inputted by the user, or based the user's inputted personal information.

12. The method according to claim 7, wherein
said step of invoking said elements define data entry and processing program comprises the user defining relationship compatibility worth and positive and negative feedback factors that may be considered in influencing the decision making process, and optionally allowing the system to generate forecasted possible outcomes or options, based on the user's inputted relationship compatibility worth, and positive and negative feedback factors; and thereafter
invoking said tracking data entry and processing program to carryout out calculations and forecast potential results and associated benefits and costs based on the relationship compatibility worth, and positive and negative feedback factors inputted by the user.

13. The method according to claim 7, wherein
said relationship compatibility worth and positive and negative feedback factors are selected from the group consisting of amount of projected sales, costs of operation and sales, amount of risk in buying or selling a business, likelihood that a business may fail, and collateral a business owner is willing to invest to insure potential business and reach sales projections.

14. The method according to claim 6, wherein
said step of invoking said calculation data entry and processing program comprises the user selecting a Net Present Value (NPV) calculation model to calculate the net cash flow of each possible future option, and the Net Present Value (NPV) of the future cash flow of each possible decision, compare the Net Present Values (NPV), and display the best option for the user to make the decision.

15. The method according to claim 14, wherein
said calculation data entry and processing program is configured to calculate net annual value (income-cost) and net present value (NPV) using the numerical values inputted by the user or according to a calculation model, according to the equation:
Discounted Cash Flow (DCF)=CF₁/+CF₂/(1+r)²+ . . . +CFₙ/(1+r)ⁿ
where cash flow is net cash flow, which is the inflows and outflows difference, r=discount rate, where the user defines the discount rate, or using the calculation model default rate, n=time period of the cash flow, and frequency may be monthly, quarterly, semiannually or annually.

16. The method according to claim 14, wherein
said calculation data entry and processing program is configured to calculate net annual value (income-cost) and net present value (NPV) using the numerical values inputted by the user or according to a calculation model, according to the equation:
$$N P V = {\sum }_{t = 0}^{n} \frac{{( Benefits - Costs )}_{t}}{{( 1 + r )}^{t}}$$
where r=discount rate, t=time and n=analytic horizon periods, benefit includes all user quantified income, including quantified personal non-monetary and emotional factors, and cost includes all user quantified costs, including quantified personal non-monetary and emotional factors.
